(19) United States
(12) Patent Application Publication
(10) Pub. No.: US 2008/0014130 A1
(43) Pub. Date: Jan. 17, 2008

(54) Apparatus to recycle atmospheric contaminants

(75) Inventor: Ruggero Maria Santilli, Palm Harbor, FL (US)

Correspondence Address: LARSON AND LARSON, 11199 69TH STREET NORTH, LARGO, FL, 33773, US

(73) Assignee: Clean Energies Tech Co., Palm Harbor, FL (US)

(21) Appl. No.: 11/485,898

(22) Filed: Jul. 13, 2006

(51) Int. Cl. B01J 19/08

(52) U.S. Cl. 422/186

(57) ABSTRACT

An apparatus for recycling a combustion exhaust into environmentally acceptable gases, where the exhaust is forced to pass through at least one electric arc, hydrocarbons and carbon monoxide in the exhaust are eliminated via their combustion or decomposition by said electric arc, carbon dioxide and nitrogen oxides in the exhaust are decomposed by the electric arc into oxygen, carbon and nitrogen to restore the oxygen depleted by fossil fuel combustion and converted into said gases, carbon and other particulates are removed by suitable filters, and a recycled exhaust released into the atmosphere is composed of nontoxic and nonpolluting gases with percentages of breathable oxygen and ozone bigger than those of the original exhaust. Various embodiments are provided that allow the use of the invention to: recycle automotive exhaust; purify urban air; and reduce global warming via large scale recycling of green house gases contained in our atmosphere into oxygen and other environmentally acceptable substances.

### FIELD OF THE INVENTION

This invention deals with novel and efficient means for recycling toxic and polluting combustion exhaust into environmentally acceptable substances.

### BACKGROUND OF THE INVENTION

Our planet is facing progressively cataclysmic climactic events caused by pollutants released by a disproportionate combustion of fossil and other fuels of various nature, such as gasoline, diesel, natural gas, biodiesel, ethanol, etc., due to the daily use of about one billion cars, one million trucks, one hundred thousand planes, plus an unknown number of agricultural and military vehicle and a very large number of fossil fueled electric power plants throughout our planet. This disproportionate consumption causes the following serious environmental problems:

1) The “green house effect”, also known as “global warming”, caused by the release into our atmosphere of an estimated one million metric tons of carbon dioxide CO2 per day as a byproduct of said fossil fuel combustion;

2) The “oxygen depletion” caused by the permanent removal of breathable oxygen from our atmosphere and its convention into CO2 that cannot be any longer recycled by plant due to its disproportionate volume as well as the dramatic decrease of forests throughout the planet;

3) The release in our atmosphere of unprecedented amounts of carcinogenic substances contained in hydrocarbons HC contained in said exhaust, plus toxic gases such as carbon monoxide CO, nitrogen oxides NO2, NO3, etc. generically written NOx, and other toxic gases.

Numerous industrial efforts have been implemented in recent times to contain such alarming release of pollutants in our atmosphere such as: automobiles have been equipped with catalytic converters to reduce the HC content in car exhausts, European petroleum companies produce the “green electricity” consisting of ordinary gasoline with hydrogen added via physical and chemical processes, and other means.

However, the above environmental problems have remained basically unsolved by available means to recycle combustion exhaust and in certain cases said problems have been enhanced. For instance catalytic converters do indeed reduce or eliminate HC via their combustion, but, in so doing, they “increase”, rather than decrease, the emission of “green gases” such as CO2. Moreover, catalytic converters need to reach full operating temperatures of the order of 800 degrees F. prior to their ability to process HC, which operating temperature generally requires 10 to 15 minutes of driving time, during which no HC processing occurs at all. Therefore, when cars are used for city commuting, 20 to 30 minutes of their daily two ways trips occur with the maximal release of contaminants in the air.

The above scenario identifies the first objectives achieved by this invention, consisting in apparatus for the recycling of automotive exhaust that: 1) Is operative at the instant of starting any engine; 2) Separates CO2 into carbon and oxygen to eliminate the production of green houses gases while restoring breathable oxygen in the exhaust; and 3) Eliminates carcinogenic HC contaminants as well as toxic CO and NOx gases either via their combustion as it is the case for HC, or via the decomposition into atomic constituents and their recombination into naturally occurring gases, as it is the case of CO and NOx.

After an exhaustive, expensive and time consuming search among all applicable means, this invention is based on the use of electric arcs because they are notoriously the most effective and efficient in the separation of molecules into their atomic constituents with no meaningful alternative, while being effective and efficient in triggering the combustion of un-combusted components of the exhaust. Next, this invention is based on flowing the exhaust of any engine through a number of arrays of electric arcs pre-set in the achievement of the desired quality of the exhaust.

After extensive search, the sole known and applicable prior art is that of U.S. Pat. No. 6,450,966 issued to this inventor, although this patent deals with the new PlasmaArcFlow™ Process consisting in flowing “liquids” through submerged electric arcs and not with “gases” as needed in this invention. Also, the utility of device described in U.S. Pat. No. 6,450,966 is in the conversion of liquid waste into a combustible fuel, and not in the use of electric arcs for recycling combustion exhaust as in this invention. Nevertheless, apart from the differences in structure, operation and utility, the physical and chemical principles in the decomposition of liquid and/or gas molecules, hereon generically referred to as fluid molecules, of this invention and U.S. Pat. No. 6,450,966 are the same because in all cases electric arcs separates said molecules into atoms and then form plasma of mostly ionized atoms around the tip of the electrodes. The flowing of fluid through the arc, as in said PlasmaArcFlow Process is necessary for efficiency and utility.

Even though the recycling of automotive exhaust is a dramatic contribution to the environment, the same recycling remains insufficient for a global solution of the serious environmental problems currently afflicting our planet.

In fact, despite the number of automobiles equipped with the exhaust recycler proposed in this invention, urban air will remain highly contaminated with carcinogenic and toxic gases while suffering from local oxygen depletion that cause health problems. Consequently, a necessary complement of this invention is the “Urban Air Purifier”, namely, an apparatus that essentially sucks urban air and releases only environmentally acceptable gases, including most importantly the restoration of the natural oxygen percentage, as described in the specifications below.

Even in the limited assumption that all vehicles in the planet are equipped with the invention herein proposed, our atmosphere remains with a large excess of green gas, CO2, that society will be forced to confront sooner or later due to its cataclysmic implications, such as the entire State of Florida being submerge by the melting of ice in the poles and consequential increase of the level of the oceans. Consequently, the third and final complement of this invention is the “Green Gas Recycler”, namely, an apparatus that converts CO2 into carbon and oxygen, as described in the specifications below.

### SUMMARY OF THE INVENTION

In these specifications we shall use: the terms “molecular separation” to denote the separation of a given gas from a gaseous mixture; the terms “molecular decomposition” to denote the breakdown of a molecule into its atomic constituents; the terms “molecular ionization” or “atomic ionization” to denote the stripping by the current of an electric arc of at least one of the peripheral electrons, thus resulting in ions as conventionally intended in physics; and “green house gas” to denote carbon dioxide and other gases responsible for the ongoing global warming; and “toxic gases” to denote any gas that is harmful to life.

With reference first to the recycling of automotive combustion exhaust, the main operating principles of this invention are the following. A conventional exhaust pipe as currently available in the underside of a car is connected to the apparatus of this invention that is also housed in said undercarriage without decreasing the clearance from the ground, which apparatus comprises: the delivery of the combustion exhaust to a pump that, in turn, delivers said exhaust along one or more exhaust pipes depending on requirements described below, and compresses said exhaust through a number of Venturi, namely, progressive restrictions on flow ending in an area surrounding an electric arc; the so treated combustion exhaust exits from the forced passage through the electric arcs is made to recombine into one or more pipes, then flow through a back pressure regulator; and is finally released in the environment.

A first advantage of the apparatus or this invention with respect to conventional catalytic converters is that the latter cause a back pressure against the natural release of the exhaust with a known damage to the proper operation of the engine. On the contrary, the apparatus of this invention can be computer controlled to create a vacuum between the exhaust manifold and said pump, with consequential facilitation, rather than restriction in the release of the exhaust and better operating conditions of the engine due to decreased engine temperature, elimination of backfires, and other advantages.

The reason for the compression of the combustion exhaust in the apparatus section between the pump and the back pressure regulator is that the efficiency of electric arcs in molecular separation, here defined as the numerical value of the ratio between the number of molecules that are processed and the used electric power, is proportional to the density of the fluid processed. Of course, the highest efficiency is obtained for the processing of liquids via electric arcs as shown in U.S. Pat. No. 6,450,966. Evidently, it is not possible to liquify the combustion exhaust due to its temperature as well as because of lack of utility due to very high costs. Compression of said exhaust then remains the only possible solution with industrial and consumer utility. Recommended operating pressures for ordinary automobiles should be restricted to about 1,000 psi with admitted peak of a maximum of 5,000 psi corresponding to the maximal pressure currently allowed by the U. S. Department of Transportation for automotive containers. Needless to say, lower or bigger operating pressures are also possible, with the smallest possible efficiency occurring for operation at atmosphere pressure.

Another important feature of the specifications of this invention is that, to maximize said efficiency, different arc arrays, that is, sequences of electric arcs in parallel connection as shown in FIG. 1, are recommended for different functions, as follows:

A) A first array of electric arcs is devoted to the easiest task, the recycling of the hydrocarbons (HC) in the exhaust. The recycling essentially occurs via the combustion of the un-combusted components of the HC as well as their molecular separation. This first process also has the function of initiating the ionization process and increasing the gas temperature, thus decreasing the power needed by the subsequent electric arcs, with consequential increase of the efficiency. This first arc array is essentially intended to replace the catalytic converters with the advantages of being active immediately following the engine start up, providing molecular decompositions that are impossible for a conventional catalytic converter as well known.

B) A second array of electric arcs is dedicated to the recycling of carbon monoxide CO that is a natural byproduct of fuel exhaust as well as of the HC combustion caused by the preceding first array of electric arcs. This second recycling occurs in part via the molecular separation of CO into carbon and oxygen atoms, with the residual part being given by the combustion of CO into CO2 permitted by the local mixture of CO and O2 traversed by an electric arc. Note that at this stage the percentage of CO2 in the exhaust is predicted to increase rather than decrease. Note also that the function of this second array is completely lacking in current catalytic converters or other means of recycling combustion exhaust.

C) A third array of electric arcs is specifically dedicated to the molecular separation of CO2 via its separation into carbon C and oxygen atoms, the latter recombining themselves into O2 as well as ozone O3, Note that O2 and O3 are released into the atmosphere; O3 is notoriously beneficial to health; and the carbon is trapped by a suitable final filter prior to final release of the processed exhaust. Note that this function too is completely lacking in catalytic converters as well as any other existing recycling of combustion exhaust.

D) A fourth array of electric arcs is dedicated to the recycling via the molecular separation of NOx as well as of residual CO2 not recycled by the preceding arrays as well as to the increase of O3 in the final release of treated exhaust since O3 occurs naturally when O2 from preceding arrays is exposed to the electric arcs. Note, again, that this fourth function is equally missing in catalytic converters as well as any other available recycling of combustion exhaust.

The apparatus is completed by exhaust analyzers, a compensating tank, a pipe with related valve and pump for the recirculation of the exhaust in the event of insufficient treatment until the achievement of the desired environmental quality of the treated exhaust, and other components identified in detail in the figures and in the specifications below.

### BRIEF DESCRIPTION OF THE DRAWINGS

In the accompanying drawings,

FIG. 1 depicts a schematic of a preferred embodiment for recycling combustion exhaust;

FIG. 2 depicts a cross-sectional view of one of the arc modules perpendicular to an exhaust flow;

FIG. 3 depicts a schematic cross-sectional view of one of the arc modules along the direction of an exhaust flow;

FIG. 4 depicts a schematic of an Urban Air Purifier; and

FIG. 5 depicts a schematic of a Green Gas Recycler.

### DETAILED DESCRIPTION OF THE INVENTION

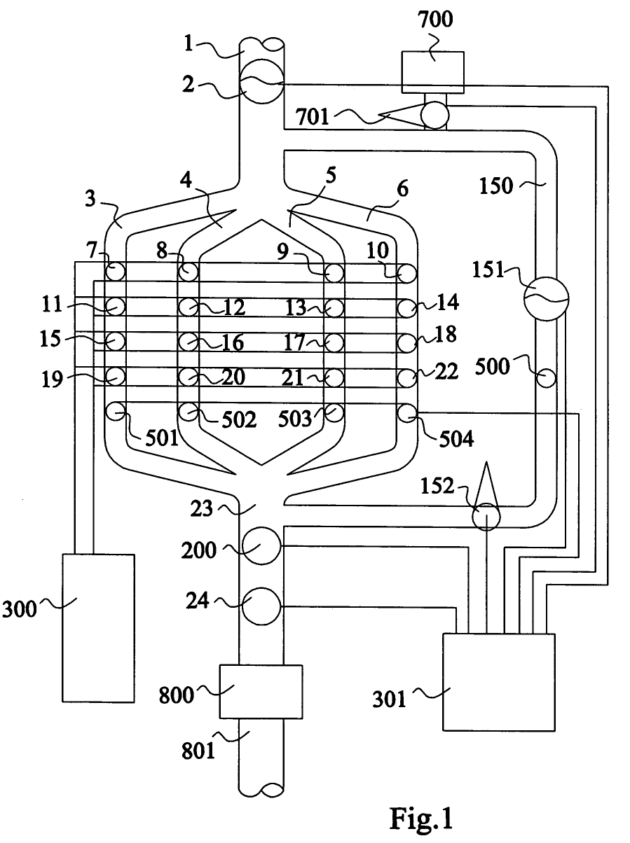

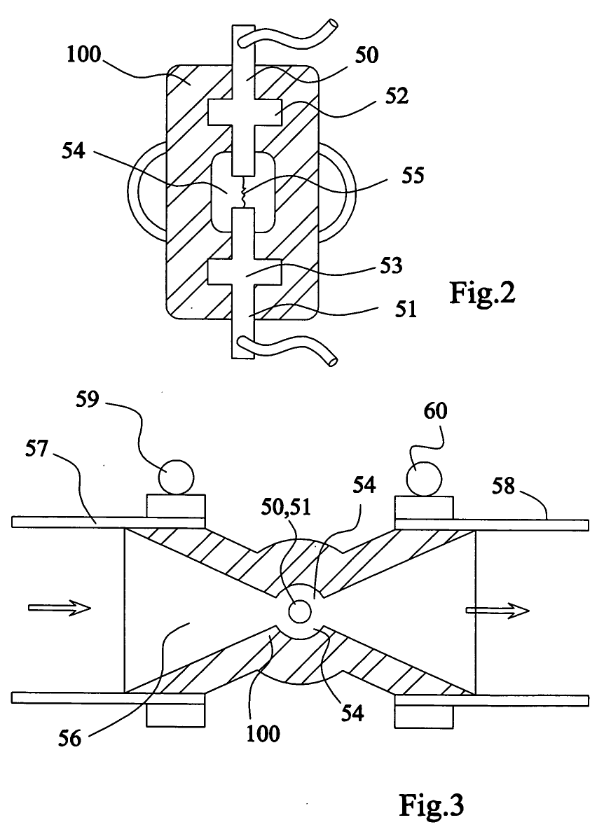

FIG. 1 depicts an example of a preferred embodiment for the recycling of automotive combustion exhaust comprising: a standard 2″ automotive exhaust pipe 1 as commercially available in existing cars; exhaust pump 2; separation of the original pipe 1 into four 1″ exhaust pipes 3, 4, 5, 6; four arrays of electric arc assemblies also called modules 7-10, 11-14, 15-18, and 19-22 described in detail in FIGS. 2, 3 presented below, interconnected also by corresponding 1″ pipes as shown in FIG. 1; recirculation pipe 150 with related valve 151 and pump 152; compensating tank 700 connected to recirculating pipe 150 via valve 701; recombination of said 1″ pipes into a 2″ exhaust pipe 23; exhaust analyzers 200, 501-504; back pressure regulator 24; final cartridge filter 800 to trap carbon and other particulates; and final exhaust pipe 801 for the release of the recycled exhaust in the atmosphere. The apparatus is then completed by power unit 300 delivering the current to said arc modules via electric connections 26-29, and computer 301 for the automatic control and management of the operations.

FIG. 2 depicts an example of a cross-sectional view of an arc module perpendicular to the direction of flow comprising: electrodes 50, 51 in thoriated tungsten or other temperature resistant conductor such as carbon-composites with ⅛″ OD and 3″ length incorporating washers 52, 53 with ½″ OD and ⅛″ thickness for locking said electrodes in a position allowing for ⅜″ gap 55; and a synthered or cast component 100 in ceramic, phenolic or similar insulating, pressure and temperature resistant material incorporating electrodes 50, 51 with their retaining washers 52, 53, and such to restrict the exhaust flow in the area 54 surrounding the electric arc and consisting of about ¼″ ID and ½″ length.

FIG. 3 depicts an example of a cross-sectional view of an arc module along the direction of flow comprising: 1″ pipe 57 and its continuation 58 after the arc module; means 59, 50 for fastening said pipes 57, 58 to a 4″ long synthered insulating component 100 internally housing a Venturi as illustrated in the figure that progressively restricts the exhaust to flow through area 54 surrounding electrodes 50, 51.

The operation of the above preferred embodiment for the recycling of automotive exhaust is the following. Immediately after engine start up, computer 301 disconnects pump 2 and backpressure regulator 24 while jointly activating all arrays of electric arcs 7-22 as well as activating exhaust analyzers 200, 500-504. In this case, the combustion exhaust is treated by the passages through the various arc arrays at the pressure of a conventional exhaust system that is slightly bigger than atmospheric pressure, such as 1.5 psi.

As soon as the final exhaust analyzer 200 detects the presence of undesired percentages of CO and/or CO2, and/or NOx and/or HC, computer 301 progressively activates: pump 2 to create a vacuum in the exhaust manifold for improved engine efficiency as indicated earlier; back pressure regulator 24 to increase the pressure in the apparatus up to 1,000 psi; and recirculation system 150 by opening the related valve 151 and activating pump 152. In this way no combustion exhaust is released to the environment until it reaches values of CO, CO2, NOx and HC pre-set in computer 301, at which point the latter decreases the pressure in back pressure regulator 24 to allow the release of the recycled exhaust in the atmosphere.

It is evident that the computer controls of this invention have to be programmed to achieve the same pre-set quality of the exhaust for all possible engine uses. This invention achieves this important result by operating the apparatus at pressures increasing with the engine power output. This implies that the operating pressure of the apparatus when the engine is at idle or in slow commuter use is expected to be of about 500 psi. With the increase of the engine power output and consequential increase of the volume of the produced exhaust, computer 301 increases the flow of pump 2 and decreases the released exhaust via the increase of back pressure in regulator 24, while activating the recirculation system 150. This feature is readily permitted for the apparatus herein considered due to the high compressibility of all gases, including combustion exhaust. Finally, under maximal rpm of the engine for protracted periods of time, the full 5,000 psi pressure is expected to be reached for an automobile of average size thus allowing maximal efficiency in the processing of the exhaust.

A 5 gallon high pressure compensating tank 700 with related valve 701 connected to recirculation pipe 150 is added in the event of rapid surges of engine rpm. In this case, computer 301 opens valve 701 allowing tank 700 to be filled up with the short term surge of exhaust and its processing without a necessary increase of pressure in back pressure regulator 24.

As indicated earlier, power 300 may consist of an ordinary dynamometer available in conventional engines or, depending on the desired quality of the exhaust, power unit 300 may consist of a specially designed electric generator added to an internal combustion engine with up to 5 Kw in power for an average size automobile, which special power unit is capable of: 1) delivering a 15,000 V DC electric current to the arc modules; and/or 2) delivering a DC current to the arc arrays pulsating with a resonating frequency of at least one of the gaseous components of the exhaust, that is, at least one resonating frequency of the CO, or CO2, or NOx or HC molecules constituting the exhaust; or 3) delivering a 15,000 V AC 60 Hz current; or 4) delivering an AC current with frequency given by at least one resonating frequency of at least one gaseous component of the exhaust. More advanced systems require different power units for each array, such as one with a resonating frequency of the CO molecule, one with a resonating frequency of the CO2 molecule and one with a resonating frequency of the NOx molecule. These different power units are not depicted in the figures because trivial for the skilled in the art and commercially available in any case.

It is evident that the pipes following the first array of electric arcs will experience an increase of temperature due to the combustion of the un-combusted components of the exhaust. However, the apparatus is exposed to the flow of air available in the undercarriage of a running car that is expected to be sufficient for cooling or, in any case, for operation at a temperature not bigger than that of catalytic converters that is of the order of 800 degrees F. In the event needed, heat radiating fins or shields can be added to the apparatus, although they are not expected to be needed as it is the case of the conventional catalytic converters.

Needless to say, the apparatus of FIGS. 1, 2, 3 does not solely apply for the recycling of automotive exhaust because it applies generically for the processing of any combustion exhaust. An illustrative case is that of a fossil fueled electric power plant in which case the apparatus of FIG. 1 is placed vertically with the final exhaust pipe 800 at the top. Then, pipe 1 may be given by a cement fluke of about 20′ in internal diameter, individual pipes 3-6 may be constituted by cement pipes of 5′ internal diameter, power unit 300 may be given by a 200 Kw unit, with corresponding increase in the pump sizes, back pressure regulator, exhaust analyzers, etc. The differentiation of pump 2 into different pumps one per each pipe 3-6 may also be advantageous for large electric power plants, although it is not indicated in the figure because trivial for the skilled in the art and based on commercially available components in any case.

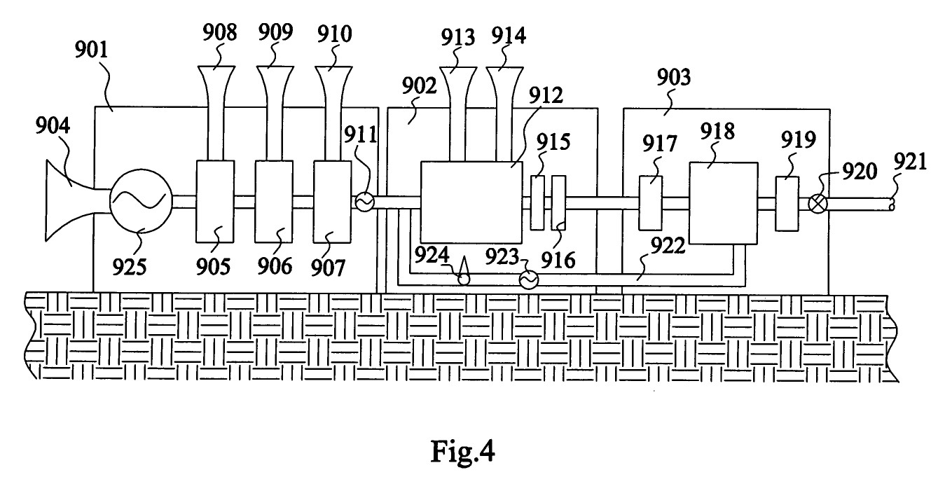

FIG. 4 presents a schematic view of a preferred embodiment of the Urban Air Purifier comprising three high pressure vessels also called stations: Station 901 for sucking contaminated urban air, molecular or other separation from said air of nitrogen, oxygen and helium with their return to the atmosphere; Station 902 for the recycling of HC, CO, CO2 and NOx gases into natural gases also released in the atmosphere; and Station 903 for the final processing of residual gases into a clean burning combustible gaseous fuel plus carbon and other particulates removed by suitable filters.

More particularly, to reach numerical values of a specific embodiment, it is here assumed that the urban air to be purified contains about 5% contaminants and has about 5% local oxygen depletion. Under these assumptions, the Urban Air Purifier of FIG. 4 is set to recycle contaminated urban air containing 73% nitrogen, rather than the conventional 80%, 16% oxygen rather than the conventional 21%, and about 1% Helium, the remaining 10% being constituted by CO2, CO, HC, NOX and other contaminants, as well as conventional gaseous components of air in small or very small percentages, such as hydrogen.. Needless to say, the above data are purely illustrative and any person skilled in the art can easily adjust the apparatus to different percentages of contaminants. This adjustment is necessary because the contamination. of urban air varies dramatically from, city to city.

Under the above indicated assumptions of contaminants, the apparatus of FIG. 4 includes: urban air inlet 904 having the ID of at least 4′; a 100 Kw pump 925 compressing the urban air to 5,000 psi at the rate of at least 1,000 scf per minute referred to said air compressed at 5,000 psi; module 905 separating nitrogen from said urban air at the projected rate of about 730 scf per minute at said compressed specifications via molecular separation processes, pressure swing adsorption or other industrially available process and then releasing the so separated nitrogen into the atmosphere via outlet 908; module 906 for the separation of oxygen at the projected rate of about 160 scf per minute and the release of oxygen and ozone via outlet 909; module 907 for the separation of helium at the projected rate of about 100 scf per minute and its release into the atmosphere via outlet 910; release of the remaining 100 scf per minute at 5,000 psi compression into Station 902 via one way check valve 911; apparatus 912 essentially identical in structure but with proportionate increase in size as that of FIGS. 1, 2, 3 for the combustion of HC, and the molecular separation of CO, CO2 and NOx; release in the atmosphere of the so produced oxygen via outlet 913 and release of the ozone via outlet 914; filter 915 for the removal of particulates produced by the preceding apparatus; release of the residual gases into Station 903 via one way check valve 916; 30 Kw pump 917 for compressing the residual gases up to 5,000 psi; pressure resistant module 918 for the separation of combustible gases, such as CO and H2 with their decomposition; final release of said combustible gas via outlet pipe 921 to an outside tank not indicated in the figure following passage through 1 micron filter 919 and back pressure regulator 920; recirculation pipe 922 for noncombustible gases separated by module 918 and their return to module 912 via pump 923 and valve 924; the above three stations being completed by at least one electric generator as in the preceding apparatus of FIGS. 1, 2 3 and related automatic controls not depicted in FIG. 4 to avoid redundancies.

The operations of the above Urban Air Purifier are completely automatic and remote controlled with automatic shut off in the event of any malfunction and paging of the operator. Initiation of operations occurs by activating pump 925 to suck urban air from an area free of solid contaminants and compress it up to the specified requirements of molecular separation, here set at 5,000 psi, with recirculating valve 924 closed and back pressure regulator 920 set at 5,000 psi. Then, Recycling stations 905, 906, 907, 912 and 918 perform their respective functions as specified above by releasing into our atmosphere nitrogen, oxygen, helium and ozone while filter 915 removes carbon and other particulates. No combustible gaseous fuel is released from outlet pipe 921 during the initiation of operation. With the increase of the operations including the recirculation modes comprised in modules 912 and 918, there is the initiation of production of a final combustible gaseous fuel that, when detected by gas analyzers as described in the preceding embodiment, is released through outlet pipe 921 by computer operated reduction of pressure in the back pressure regulator 919. At that point the computer also opens valve 924 and activates motor 923 for the recirculation of contaminated residual gases in Station 903. Cartridges in filters 907 and 919 are periodically replaced as per specifications of their manufacturers. Operations can then continue 24 hours a day and are interrupted automatically only in the event of lack of flow causes by clocking up of pipes or other possible malfunctions.

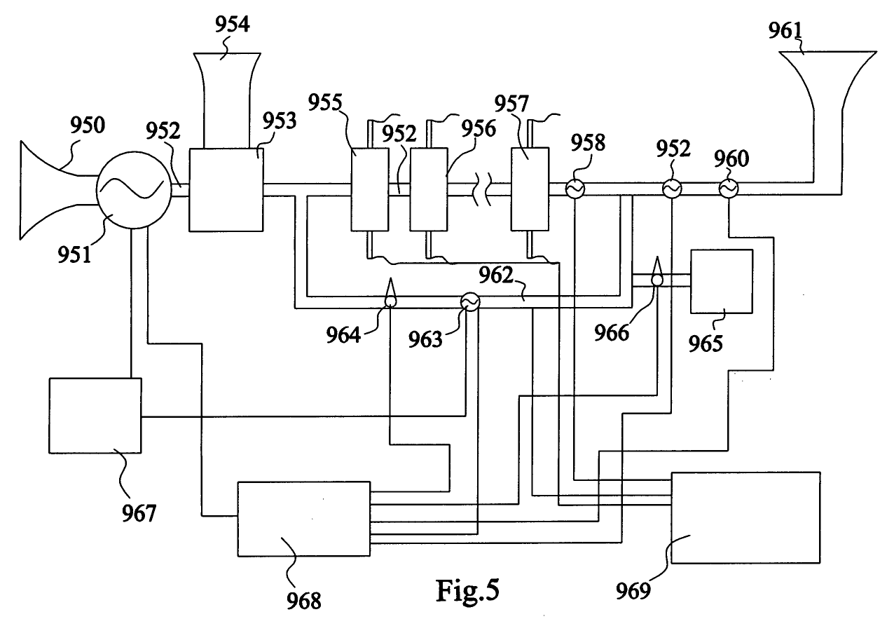

FIG. 5 depicts a preferred embodiment of the Green Gas Recycler and comprises: 100′ diameter air inlet 950; 500 Kw compressor 95 capable of sucking five millions scf of atmospheric air per minute and compressing it to 5,000 psi through pipe 952 into CO2 separator station 953 sending said CO2 gas to the rest of the apparatus, while releasing via outlet pipe 954 all remaining components; the PlasmaArcFlow modules 955, 956, 957 as in FIGS. 2, 3 although with all dimension increased fifty times placed in series for the molecular separation of CO2; a CO2 gas analyzer 958; at least one filter 959; a back pressure regulator 960; final exhaust pipe 961; recirculation pipe 962 with pump 963 and valve 964; compensating tank 965 connected to recirculation pipe 962 with valve 966; plus various analyzers sensors and controls not shown in the figure because trivial for the skilled in the art.

The operations of the Green Gas Recycler is completely automatic with remote controls. Computer 969 starts pump 951 by activating electric power system 967 representing either an electric generator or the grid depending on location, sets back pressure regulator 960 to 5,000 psi, activates molecular separation module 953 with consequential transfer of CO2 to the rest of the apparatus and release of the remaining component into the atmosphere, and initiates the arcs in modules 955, 956, 957 by activating the AC or DC electric power 968. If CO2 analyzer 958 senses insufficient decomposition of CO2, computer 969 activates recirculation pipe 962 by opening valve 964 and starting electric motor 963. When CO2 analyzer 958 senses an acceptable level of oxygen corresponding to a pre-set minimum value of CO2 of the order of 1%, computer 969 decreases the pressure in back pressure regulator 960 to allow the so produced oxygen and ozone to be released into the atmosphere through outlet 961 following removal of particulates via filter 959. The operation the continues 24 hours a day unless halted by computer 969 because of breakdown of one of the motor or power units via sensors not shown in the figure because trivial for the skilled in the art and industrially available in any case.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

I claim:

1. A pressure and temperature resistant apparatus for recycling a combustion exhaust into environmentally acceptable gases, comprising:
means for flowing a combustion exhaust through the area immediately surrounding at least one electric arc between a pair of electrodes, wherein
hydrocarbons and carbon monoxide in said exhaust are eliminated via their combustion or molecular separation caused by said electric arc,
carbon dioxide and nitrogen oxides in said exhaust are decomposed by said electric arc into their atomic constituents with consequential production of carbon removed by a filter, and ordinary oxygen, ozone and nitrogen gases released in the atmosphere, and
wherein the recycled exhaust released into the atmosphere contains a percentages of breathable oxygen and ozone bigger than those of the original exhaust without toxic, pollutants or green house gases.

2. The apparatus as per claim 1, further comprising means for creating a vacuum between said apparatus and the exhaust manifold.

3. The apparatus as per claim 1, further comprising a back pressure regulator prior to the release of the recycled exhaust into the atmosphere.

4. The apparatus as per claim 1, further comprising means for the recirculation of the exhaust through at least one electric arc prior to its release into the atmosphere.

5. The apparatus as per claim 1, further comprising exhaust analyzers usable to prevent the release of the exhaust in the atmosphere prior to the achievement of pre-set environmental qualities.

6. The apparatus as per claim 1, further comprising a compensating tank to accommodate rapid surges of exhaust.

7. The apparatus as per claim 1, further comprising computerized automatic controls allowing the sole release of recycled combustion exhaust having pre-set environmental qualities.

8. The apparatus as per claim 1, further comprising at least one DC power unit sufficient to create said arc.

9. The apparatus as per claim 1, further comprising at least one AC power unit sufficient to create said arc.

10. The apparatus as per claim 1, further comprising at least one power unit delivering a pulsating DC electric current to said arc with at least one of the resonating frequencies of said exhaust.

11. The apparatus as per claim 1, further comprising at least one power unit delivering an AC current with at least one of the resonating frequencies of said exhaust.

12. An apparatus for the purification of urban air comprising:
a pressure and temperature resistant vessel for the separation of the nitrogen, oxygen and helium from said urban air and their release into the atmosphere,
a pressure and temperature resistant vessel forcing the residual components of said urban air to pass through the immediate vicinity of at least one electric arc between a pair of electrodes, by therefore causing the combustion of the combustible components of said urban air or their molecular separation into atomic components, with the release into the atmosphere of oxygen and ozone,
a pressure and temperature resistant vessel for the processing of residual gases into a clean burning gas for a fuel usage and the removal of carbon and other particles,
wherein only naturally occurring gases are released into the atmosphere with percentages of oxygen and ozone bigger than those occurring in atmosphere.

13. The apparatus as per claim 12, further comprising a back pressure regulator prior to the release of the recycled air into the atmosphere.

14. The apparatus as per claim 12, further comprising means for the recirculation of the air through at least one electric arc prior to its release into the atmosphere.

15. The apparatus as per claim 12, further comprising gas analyzers usable to prevent the release of contaminants in the atmosphere.

16. The apparatus as per claim 12, further comprising computerized automatic controls allowing the sole release of recycled air having pre-set environmental qualities.

17. The apparatus as per claim 12, further comprising at least one DC power unit sufficient to create said arc.

18. The apparatus as per claim 12 further comprising at least one AC power unit sufficient to create said arc.

19. The apparatus as per claim 12, further comprising at least one power unit delivering a pulsating DC electric current to said arc with at least one of the resonating frequencies of atmospheric gases.

20. The apparatus as per claim 12, further comprising at least one power unit delivering an AC current with at least one of the resonating frequencies of atmospheric gases.

21. An apparatus for the recycling of atmospheric carbon dioxide into breathable oxygen, ozone and carbon comprising along a line of flow:
a first pressure resistant vessel to suck air, separate carbon dioxide and release into the atmosphere the remaining components,
a second pressure resistant vessel to force the flowing of carbon dioxide through an area immediately surrounding at last one electric arc between a pair of electrodes, with consequential processing of said carbon dioxide into carbon, oxygen and ozone and to release said oxygen into the atmosphere,
means for collecting carbon and other solids,
wherein the oxygen removed from the atmosphere by carbon combustion and converted into carbon dioxide is restored to its original breathable condition.

22. The apparatus as per claim 21, further comprising a back pressure regulator prior to the release of oxygen and ozone into the atmosphere.

23. The apparatus as per claim 21, further comprising means for the recirculation of carbon dioxide through at least one electric arc.

24. The apparatus as per claim 21, further comprising gas analyzers usable to prevent the release of contaminants in the atmosphere.

25. The apparatus as per claim 21, further comprising computerized automatic controls permitting the sole release into the atmosphere of oxygen and ozone.

26. The apparatus as per claim 21, further comprising at least one DC power unit sufficient to create said arc.

27. The apparatus as per claim 21, further comprising at least one AC power unit sufficient to create said arc.

28. The apparatus as per claim 21, further comprising at least one power unit delivering a pulsating DC electric current to said arc with at least one of the resonating frequencies of carbon dioxide.

29. The apparatus as per claim 21, further comprising at least one power unit delivering an AC current with at least one of the resonating frequencies of carbon dioxide.
